(19) United States
(12) Patent Application Publication
(10) Pub. No.: US 2014/0229857 A1
(43) Pub. Date: Aug. 14, 2014

(54) Initiating Actions on a Third-Party System Through Interaction with a Social Networking System

(71) Applicant: Facebook, Inc., Menlo Park, CA (US)

(72) Inventors: Austin Daniel Haugen, San Francisco, CA (US); Zachary Rait, Palo Alto, CA (US); Alex Himel, Palo Alto, CA (US); Alexander Scott Wyler, Redwood City, CA (US)

(73) Assignee: Facebook, Inc., Menlo Park, CA (US)

(21) Appl. No.: 13/765,607

(22) Filed: Feb. 12, 2013

(51) Int. Cl. H04L 29/08

(52) U.S. Cl. CPC H04L 67/22
USPC 715/753

(57) ABSTRACT

By interacting with an interface element associated with a third-party system and presented by a social networking system, a user of the social networking system performs an action on the third-party system. For example, the interface element is displayed in a story describing content from the third-party system. The interface element is associated with an action performed on the third-party system, so when a user accesses the interface element a request to perform the action is sent from the social networking system to the third-party system. When the third-party system performs the action, a description of the action is sent back to the social networking system, which may present a confirmation of the action to the user. For example, the appearance of the interface element is modified to indicate that the action was performed.

### BACKGROUND

This invention relates generally to social networking systems and in particular to communicating requests for actions from a social networking system to a third-party system.

Social networking systems, or social utilities that track and enable connections between users (including people, businesses, and other entities), have become prevalent in recent years. These social networking systems allow users to more efficiently communicate information. For example, a social networking system user may post contact information, background information, job information, hobbies, and/or other user-specific data to the social networking system. Other users may then review the posted data by browsing user profiles or searching for profiles including specific data. Social networking systems also allow users to associate themselves with other users, creating a web of connections among the users of the social networking system. The social networking system may use these connections to provide users with more relevant information.

Users of a social networking system frequently maintain accounts on systems or applications outside of the social networking system, commonly referred to as “third-party systems” or “third-party applications.” These third-party systems or third-party applications may communicate actions to a social networking system for association with a social networking system user performing the actions. Various third-party systems or third-party applications may specify actions and/or objects that are communicated to the social networking system to describe interactions with a third-party system or third-party application. The social networking system may then generate stories or messages information other users of the interactions with a third-party system or with a third-party application.

While social networking systems notify users of interactions with a third-party system by other users, conventional social networking systems do not allow their users to interact with the third-party system with which another user interacted. A social networking system may comment on, express a preference for, share, or otherwise interact with a story or message describing an interaction with a third-party system, but these interactions are limited to the social networking system. For example, a conventional social networking system notifies users of another user's purchase of a product from a third-party system and allows users to interact with the notification describing the purchase by allowing users to express a preference for or to comment on the notification. However, users are unable to interact with the third-party system from the social networking system. In the preceding examples, users are unable to purchase the product included in the notification without separately accessing the third-party system.

### SUMMARY

Third-party systems may provide content to a social networking system for presentation to social networking system users. For example, a third-party system communicates a description of an action performed on the third-party system, a description of a promotion offered by the third-party system, a description of products or services offered by the third-party system, or other suitable information to the social networking system. The social networking system generates a story or message based on the content from the third-party system and presents the story or message to one or more social networking system users.

To allow social networking system users to more easily interact with the third-party system, the story or message includes an interface element associated with an action performed by the third-party system. When a user interacts with the interface element, a request to perform the associated action is communicated from the social networking system to the third-party system. For example, the request includes information identifying the user interacting with the interface element, a command to perform the action, and any other suitable information (e.g., an object on which the action is performed). Based on the request, the third-party system retrieves an account corresponding to the information identifying the user and performs the action specified by the request. For example, the request identifies a movie for a specified user to rent, so the third-party system retrieves an account associated with the specified user and adds the movie to a rental queue in the account.

In one embodiment, the third-party system communicates a description of the action back to the social networking system. For example, the third-party system communicates a confirmation that the action was performed to the social networking system. The social networking system may notify other users of the action on the third-party system to encourage additional users to interact with the third-party system. Additionally, the social networking system may modify the interface element presented to the user that interacted with the interface element to indicate that the action was performed or may otherwise provide a confirmation of the action to the user that interacted with the interface element.

### BRIEF DESCRIPTION OF THE DRAWINGS

FIG. 1 is an interaction diagram of a method for communicating a request to perform an action from a social networking system to a third-party system, in accordance with one embodiment.

FIG. 2 is a block diagram of a system environment in which an online system operates, in accordance with an embodiment.

FIG. 3 is a block diagram of a social networking system, in accordance with an embodiment.

FIG. 4 is a flowchart of a method for communicating requests for actions from a social networking system to a third-party system, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

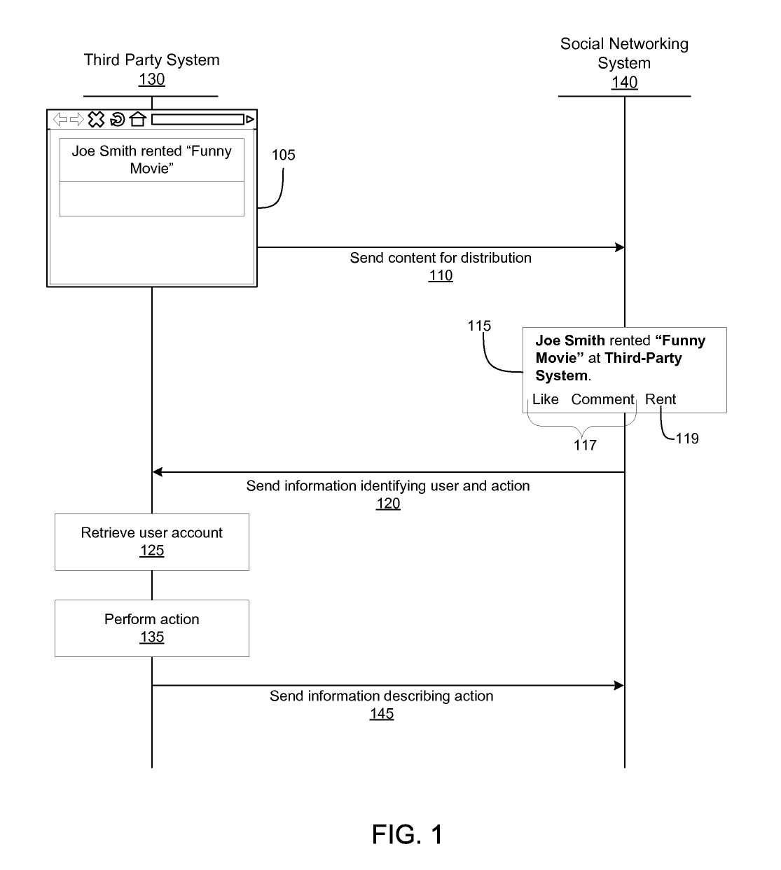

FIG. 1 illustrates one embodiment of a method for communicating requests for action from a social networking system 140 to a third-party system 130. The third-party system 130 sends 110 content to the social networking system 140 for distribution to social networking system users. In the example shown by FIG. 1, a third-party system user performs 105 an action with the third-party system 130 through a client application. For example, the user interacts with a web page associated with the third-party system 130 or interacts with a native application associated with the third-party system 130. Information describing the third-party system 130 and describing the action (e.g., indicating whether the action is a purchase, a rating, a request for information, a subscription, a rental or the like) to the social networking system 140. The information may specify a type of action and may include additional information associated with the action. For example, the information may identify an item purchased or rented or other suitable information. Alternatively, the third-party system 130 sends 110 the social networking system 140 information describing a promotion by the third-party system 130, describing products or services offered by the third-party system 130, or describing any other suitable information associated with the third-party system 130.

If a description of an action by a user is sent 110 by the third-party system, the third-party system 130 and/or the social networking system 140 determine whether the user is associated with a user profile maintained by the social networking system 140. For example, the third party system 130 may access a cookie stored on the device used by the user to perform the action and associated with the social networking system 130. As the social networking system 140 and the third-party system 130 are on different domains, the application used to perform the action may include security features that normally prevent a website from one domain from accessing content on other domains, so various methods may be used to allow the social networking system 140 to access the cookie. For example, if the application is a browser, the third-party website 130 may use nested iframes, where the third-party system 130 serves a web page including a nested iframe in the social networking system's domain, allowing the nested iframe to access the user information and send the information back to the third-party system 130. Repeated nesting of iframes further allows the social networking system 140 to communicate information back to the third-party system 130. By using this technique, the third-party system 130 and the social networking system 140 may communicate about the user without sharing any of the user's personal information and without requiring the user to log into the social networking system 140. Alternatively, the information describing the action may include user identifying information (e.g., a login name for the social networking system 140, a login name for the third-party system 130, or any other suitable information).

Based on the content received from the third-party system 130, the social networking system 140 generates 115 a description of the content, stores the content and associates the content with a user profile corresponding to the third-party system 130. If a description of an action performed bon the third-party system 130 is received, the social networking system 140 stores the information and associates the stored information with the user profile of the user that performed the action. In some embodiments, such as the one shown by FIG. 1, the social networking system 140 generates 115 a story or other message describing the content that is presented to users of the social networking system 140. For example, a story describing the content is presented to users of the social networking system 140 connected to a user profile associated with the third-party system 130.

As shown in FIG. 1, the story or message identifies the content received from the third-party system, which may identify a social networking system user that performed an action, and includes interface elements 117, 119. One or more interface elements 117 are associated with actions performed by the social networking system 140 so interacting with an interface element 117 causes the social networking system 140 to perform an action corresponding to the interface element 117. Additionally, one or more interface elements 119 are associated with actions performed by the third-party system 130. The third-party system 130 may provide the social networking system 140 with a description of an interface element 119 associated with the third-party system 130, allowing various third-party systems 130 to customize the appearance of associated interface elements 119 and the actions performed by associated interface elements 119. In one embodiment, the description of the interface element 119 is sent 110 from the third-party system 130 to the social networking system 140 along with the content for distribution. Alternatively, the social networking system 140 stores descriptions of interface elements 119 associated with a third-party system 130 and retrieves a stored description of an interface element 119 when content for presentation is received from the third-party system 130.

Interacting with an interface element 119 associated with an action performed by the third-party system 130 sends 120 information describing the user interacting with the interface element 119 and the action to the third-party system 130 from the social networking system 140. For example, a request to perform the action associated with the interface element 119 that includes user identifying information (e.g., a login for the user to the third-party system 130, a login for the user to the social networking system 140, etc.) and a description of the action associated with the interface element 119 is sent 120 to the third-party system 130. The request may include any other suitable information, such as an object on which the action is to be performed, such as an object identified by the message or story.

Based on the information sent 120 by the social networking system 140, the third-party system 130 retrieves 125 a user account corresponding to the received information and maintained by the third-party system 130 and performs 135 the action identified by the received information. In one embodiment, the third-party system 130 retrieves 125 the user account, identifies an object, and performs an action based on parameters specified by a request received from the social networking system 140. For example, the third-party system 130 retrieves 125 a user account and purchases an item described in a story or message presented by the social networking system 140 based on the information sent 120 by the social networking system 140. This allows social networking system users to more easily interact with the third-party system 130 by enabling social networking system users to request actions to be performed on the third-party system 130 using the social networking system 140.

After performing 135 the action identified by the sent information, the third-party system 130 sends 145 information describing the action to the social networking system 130. For example, the information describing the action is a confirmation message indicating the action was performed. The social networking system 140 may store the confirmation message and associate the confirmation message with the user that interacted with the interface element 119 associated with the third-party system 130. In one embodiment, the social networking system 140 modifies the interface element 119 associated with the third-party system 130 when a confirmation message is received to visually indicate the action was performed. For example, if the interface element 119 associated with the third-party system 130 is initially text data stating “Buy this item,” after a confirmation that the third-party system 130 purchased the item for a user, the story or message presented to the user presents a modified interface element 119 associated with the third party system 130 providing “Bought.” Hence, modifying the interface element 119 allows the social networking system 140 to confirm to a user that a requested action was performed by the third-party system 130.

### System Architecture

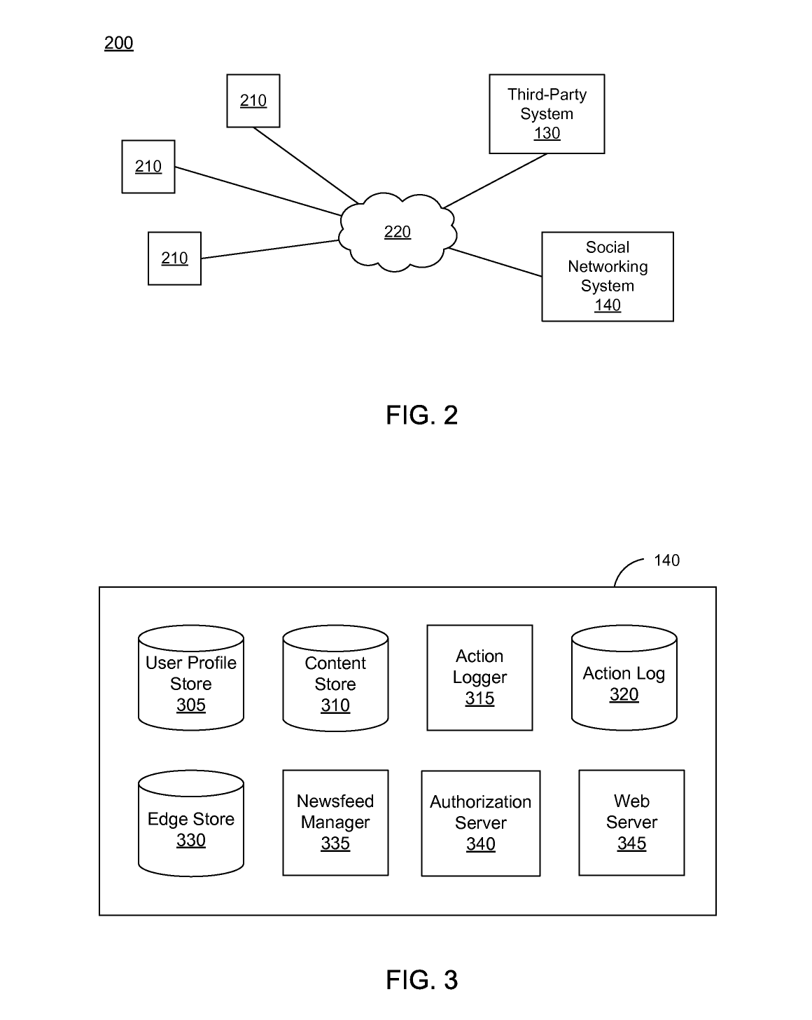

FIG. 2 is a high level block diagram illustrating a system environment 200 for an online system. The system environment 200 comprises one or more client devices 210, a network 220, one or more third-party systems 130, and the social networking system 140. In alternative configurations, different and/or additional components may be included in the system environment 200. While described with reference to the social networking system 140, the embodiments described herein may be adapted to online systems that are not social networking systems 140.

A client device 210 is a computing device capable of receiving user input as well as transmitting and/or receiving data via the network 220. In one embodiment, a client device 210 is a conventional computer system, such as a desktop or laptop computer. In another embodiment, a client device 210 may be a device having computer functionality, such as a personal digital assistant (PDA), mobile telephone, smart-phone or similar device. A client device 210 is configured to communicate via the network 220. In one embodiment, a client device 210 executes an application allowing a user of the client device 210 to interact with the social networking system 140. For example, a client device 210 executes a browser application to enable interaction between the client device 210 and the social networking system 140 via the network 220. In another embodiment, a client device 210 interacts with the social networking system 140 through an application programming interface (API) that runs on the native operating system of the client device 210, such as IOS® or ANDROID™.

The client devices 210 are configured to communicate via the network 220, which may comprise any combination of local area and/or wide area networks, using both wired and wireless communication systems. In one embodiment, the network 220 uses standard communications technologies and/or protocols. Thus, the network 220 may include links using technologies such as Ethernet, 802.11, worldwide interoperability for microwave access (WiMAX), 3G, 4G, code division multiple access (CDMA), digital subscriber line (DSL), etc. Similarly, the networking protocols used on the network 220 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 220 may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec).

One or more third party systems 130 may be coupled to the network 220 for communicating with the social networking system 140, which is further described below in conjunction with FIG. 3. In one embodiment, the third party system 130 is an application provider communicating information describing third-party applications for execution by a client device 210 or communicating data to client devices 210 for presentation. The third party system 130 may also communicate information to the social networking system 140, such as advertisements or information about an application provided by the third party website 130. In various embodiments, a third-party system 130 is associated with a domain that differs from the domain associated with the social networking system 140.

FIG. 3 is an example block diagram of an architecture of the social networking system 140. The social networking system 140 includes a user profile store 305, a content store 310, an action logger 315, an action log 320, an edge store 330, a newsfeed manager 335, an authorization server 340, and a web server 345. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 305. A user profile includes declarative information about the user that was explicitly shared by the user, and may also include profile information inferred by the social networking system 140. In one embodiment, a user profile includes multiple data fields, each data field describing one or more attributes of the corresponding user of the social networking system 140. The user profile information stored in user profile store 305 describes the users of the social networking system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 140 displayed in an image. A user profile in the user profile store 305 may also maintain references to actions by the corresponding user performed on content items in the content store 310 and stored in the action log 320.

While user profiles in the user profile store 305 are frequently associated with individuals, allowing people to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system 140 using a brand page associated with the entity's user profile. Other users of the social networking system 140 may connect to the brand page to receive information posted to the brand page or to receive information from the brand page. A user profile associated with the brand page may include information about the entity itself, providing users with background or informational data about the entity.

The content store 310 stores objects representing various types of content. Examples of content represented by an object include a page post, a status update, a photo, a video, a link, a shared content item, a gaming application achievement, a check-in event at a local business, a brand page, or any other type of content. Objects may be created by users of the social networking system 140, such as status updates, photos tagged by users to be associated with other objects in the social networking system, events, groups or applications. In some embodiments, objects are received from third-party applications, which may be external to the social networking system 140. Content “items” represent single pieces of content that are represented as objects in the social networking system 140. Users of the social networking system 140 are encouraged to communicate with each other by posting text and content items of various types of media through various communication channels, increasing the interaction of users with each other and increasing the frequency with which users interact within the social networking system 140.

In one embodiment, the content store 310 includes descriptions for interface elements presented along with content. An interface element is presented to a user and is associated with an action, so interacting with an interface element causes the action associated with the interface element to be performed. As described above in conjunction with FIG. 1, an interface element may be associated with a third-party system 130 so a request to perform an action is communicated to the third-party system 130 for execution when a user interacts with the interface element. The third-party system 130 may customize the presentation of an interface element and associate an action with an interface element for the third-party system to perform. To customize an interface element, a third-party system 130 communicates a definition of the interface element to the social networking system 140, which stores the definition in the content store 310. In one embodiment, the definition is associated with a user profile of the third-party system 130 or includes an identifier of its associated third-party system 130. The definition may identify one or more of the format with which the interface element is presented, a command executable by the third-party system 130, an alternate format used to present the interface element when the action has been performed on the third-party system 130, or any other suitable information.

The action logger 315 receives communications about user actions on and/or off the social networking system 140, populating the action log 320 with information about user actions. Such actions may include, for example, adding a connection to another user, sending a message to another user, uploading an image, reading a message from another user, viewing content associated with another user, attending an event posted by another user, interacting with a link included in a news story or advertisement, among others. In some embodiments, the action logger 315 identifies interaction between a social networking system user and a brand page within the social networking system 140, which communicates targeting criteria associated with content on the brand page to a content selector to customize content from the brand page. In addition, a number of actions described in connection with other objects are directed at particular users, so these actions are associated with those users as well. These actions are stored in the action log 320. In one embodiment, the action logger 315 notifies a user that performed a logged action of another user performing an action associated with the logged action. For example, the action logger 315 sends a notification message to a user that posted content to the social networking system 140 identifying another user that expressed a preference for the posted content or that shared the posted content. The notification message may be sent using any suitable communication channel.

The action log 320 may be used by the social networking system 140 to track user actions on the social networking system 140, as well as external websites 130 that communicate information to the social networking system 140. Users may interact with various objects on the social networking system 140, including commenting on posts, sharing links, and checking-in to physical locations via a mobile device, accessing content items or other interactions. Information describing these actions is stored in the action log 320. Additional examples of interactions with objects on the social networking system 140 included in the action log 320 include commenting on a photo album, communications between users, becoming a fan of a musician, adding an event to a calendar, joining a groups, becoming a fan of a brand page, creating an event, authorizing an application, using an application, interacting with an interface element, and engaging in a transaction. Additionally, the action log 320 records a user's interactions with advertisements on the social networking system 140 as well as other applications operating on the social networking system 140. For example, the action log 320 stores a user's interactions with notifications and with content included in the notifications, such as a link. In some embodiments, data from the action log 320 is used to infer interests or preferences of the user, augmenting the interests included in the user profile and allowing a more complete understanding of user preferences.

The action log 320 may also store user actions taken on systems external to the social networking system 140, such as a third-party system 130. In one embodiment, the action log 320 associates identifiers from a third-party system 130 used by the third-party system 130 to identify an action. For example, the action long 320 maintains an identifier associated with an action by the social networking system 140 as well as a third-party identifier associated with the action by the third-party system 130 on which the action was performed, and from which information describing the action was received. As an example of an action taken on a system external to the social networking system 130, an e-commerce website that primarily sells sporting equipment at bargain prices may recognize a user of a social networking system 140 through social plug-ins that enable the e-commerce website to identify the user of the social networking system 140. Because users of the social networking system 140 are uniquely identifiable, e-commerce websites, such as this sporting equipment retailer, may use the information about these users as they visit their websites. The action log 320 records data about these users, including webpage viewing histories, advertisements that were engaged, purchases made, and other patterns from shopping and buying.

In one embodiment, an edge store 330 stores the information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

The edge store 330 stores information describing characteristics of edges, such as affinity scores for objects, interests, and other users. Affinity scores may be computed by the social networking system 140 over time to approximate a user's affinity for an object, interest, and other users in the social networking system 140 based on the actions performed by the user. A user's affinity may be computed by the social networking system 140 over time to approximate a user's affinity for an object, interest, and other users in the social networking system 140 based on the actions performed by the user. Computation of affinity is further described in U.S. patent application Ser. No. 12/978,265, filed on Dec. 23, 2010, which is hereby incorporated by reference in its entirety. Multiple interactions between a user and a specific object may be stored in one edge object in the edge store 330, in one embodiment. In some embodiments, connections between users may be stored in the user profile store 305, or the user profile store 305 may access the edge store 330 to determine connections between users.

Data stored in the user profile store 305, the content store 310, the action log 320, and the edge store 330 enables the social networking system 140 to generate a social graph that uses nodes to identify various objects and edges connecting nodes to identify relationships between different objects resulting from an action that was performed by one of the nodes on the other node. Building upon this understanding of a social graph, which comprises nodes and edges, the social graph can be “opened” by enabling third-party developers and third-party systems 130 to define objects and actions that imitate real-world interactions to be published to the social graph. For example, as users of the social networking system 140 use third party systems 130, their actions external to the social networking system 140 may be captured and reported to the social networking system 140. Hence, a third party system 130 reports a user's interaction according to structured actions and objects in the social graph. The action logger 315 interprets the received interaction according to the definitions of the action and object maintained by the social networking system 140, allowing the interaction to be included in the social graph.

A newsfeed manager 335 selects candidate stories from content store 310 and analyzes the candidate stories to select stores included in a newsfeed. Information from additional components of social networking system 140, such as the user profile store 305, the action log 320, and the edge store 330, is also retrieved and used by newsfeed manger 335 to generate a newsfeed personalized for a user of social networking system 140. For example, the newsfeed manager 335 receives an instruction identifying a user accessing social networking system 130 and accesses one or more of user profile store 305, the content store 310, the action log 320, and the edge store 330, or other suitable sources and retrieves information about the identified user as well as stories or other data. In one embodiment, stories or other data associated with users connected to the identified user are retrieved. The retrieved stories and other data are filtered by the newsfeed manager 335 to identify content likely to be relevant to the identified user. For example, stories associated with users not connected to the identified user are not identified as candidate stories or stories associated with users to which the identified user has less than a threshold affinity are not identified as candidate stories. In one embodiment, the newsfeed manager 335 may identify stories associated with users to which the identified user is inferentially connected, such as stories associated with users connected to an additional user that is connected to the identified user, as candidate stories. For example, the newsfeed manager 335 selects stories communicated between two users connected to the identified user as candidate stories.

In various embodiments, a newsfeed generated by the newsfeed manager 335 is a dynamic list that may include a complete listing of candidate stories or may include a limited number of candidate stories. The number of stories included in a newsfeed may be determined in part by a user preference included in user profile store 310. As described above, the newsfeed manager 335 identifies stories for presentation through a newsfeed as well as the order in which identified stories are presented by the newsfeed. For example, the newsfeed manager 335 determines that a user has a highest affinity for a specific user and increases the number of stories in the newsfeed associated with the specific user. The newsfeed manager 335 may also account for actions by a user that indicate preferences for types of stories and selects stories having the same, or similar, types for inclusion in the newsfeed. Additionally, the newsfeed manager 335 may analyze stories received by social networking system 140 from various users and obtains information about user preferences or actions from the analyzed stories. This information may be used to refine selection of stories for newsfeeds presented to various users.

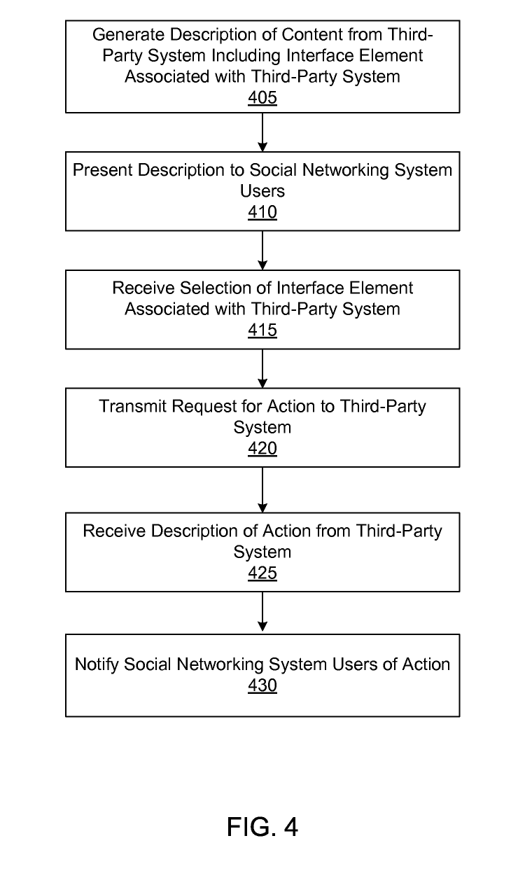

A story presented by the newsfeed manager 335 identifies an action and a user that performed the action. One or more objects associated with the identified action may also be included in the story. This allows a user to identify actions performed by other social networking system users. The newsfeed manager 335 may update a story to include additional actions associated with the story, or with a user, an action, or an object identified by the story. A story also includes one or more interface elements each associated with an action. Hence, when a user viewing a story interacts with an interface element, a request to perform the corresponding action is communicated to a component along with information for performing the action. As described above, an interface element may be associated with a third-party system 130, so interacting with the interface element communicates a request to the third-party system 130 to perform the action associated with the interface element, which is further described below in conjunction with FIG. 4.

The authorization server 340 enforces one or more privacy settings of the users of the social networking system 140. A privacy setting of a user determines how particular information associated with a user can be shared, and may be stored in the user profile of a user in the user profile store 305 or stored in the authorization server 340 and associated with a user profile. In one embodiment, a privacy setting specifies particular information associated with a user and identifies the entity or entities with whom the specified information may be shared. Examples of entities with which information can be shared may include other users, applications, third-party systems 130 or any entity that can potentially access the information. Examples of information that can be shared by a user include user profile information like profile photo, phone numbers associated with the user, user's connections, actions taken by the user such as adding a connection, changing user profile information and the like.

The privacy setting specification may be provided at different levels of granularity. In one embodiment, a privacy setting may identify specific information to be shared with other users. For example, the privacy setting identifies a work phone number or a specific set of related information, such as, personal information including profile photo, home phone number, and status. Alternatively, the privacy setting may apply to all the information associated with the user. Specification of the set of entities that can access particular information may also be specified at various levels of granularity. Various sets of entities with which information can be shared may include, for example, all users connected to the user, a set of users connected to the user, additional users connected to users connected to the user all applications, all third-party systems 130, specific third-party systems 130, or all external systems.

One embodiment uses an enumeration of entities to specify the entities allowed to access identified information or to identify types of information presented to different entities. For example, the user may specify types of actions that are communicated to other users or communicated to a specified group of users. Alternatively, the user may specify types of actions or other information that is not published or presented to other users.

The authorization server 340 includes logic to determine if certain information associated with a user can be accessed by a user's friends, third-party system 130 and/or other applications and entities. For example, a third-party system 130 that attempts to access a user's comment about a uniform resource locator (URL) associated with the third-party system 130 must get authorization from the authorization server 340 to access information associated with the user. Based on the user's privacy settings, the authorization server 340 determines if another user, a third-party system 130, an application or another entity is allowed to access information associated with the user, including information about actions taken by the user. For example, the authorization server 340 uses a user's privacy setting to determine if the user's comment about a URL associated with the third-party system 130 can be presented to the third-party system 130 or can be presented to another user. This enables a user's privacy setting to specify which other users, or other entities, are allowed to receive data about the user's actions or other data associated with the user.

The web server 345 links the social networking system 140 via the network 220 to the one or more client devices 210, as well as to the one or more third party websites 130. The web server 140 serves web pages, as well as other web-related content, such as JAVA®, FLASH®, XML and so forth. The web server 345 may provide the functionality of receiving and routing messages between the social networking system 140 and the client device 210, for example, instant messages, queued messages (e.g., email), text and SMS (short message service) messages, or messages sent using any other suitable messaging technique. A user may send a request to the web server 345 to upload information, for example, images or videos that are stored in the content store 210. Additionally, the web server 345 may provide application programming interface (API) functionality to send data directly to native client device operating systems, such as IOS®, ANDROID™, WEBOS® or RIM.

The web server 345 links the social networking system 140 via the network 220 to the one or more client devices 210, as well as to the one or more third-party systems 130. The web server 240 serves web pages, as well as other web-related content, such as JAVA®, FLASH®, extensible markup language (XML) and so forth. The web server 345 may receive and route messages between the social networking system 140 and the client device 110, for example, instant messages, queued messages (e.g., email), text and short message service (SMS) messages, or messages sent using any other suitable messaging technique. A user may send a request to the web server 345 to upload information, for example, images or videos that are stored in the content store 310. Additionally, the web server 345 may provide application programming interface (API) functionality to send data directly to native client device operating systems, such as IOS®, ANDROID™, WEBOS® or RIM®.

### Communicating Requests for Actions to a Third-Party System

FIG. 4 is a flowchart of one embodiment of a method for communicating requests for actions from a social networking system 140 to a third-party system 130. The newsfeed manager 335 generates 405 a description of content from a third-party system 130 that includes at least one interface element associated with the third-party system 130. As shown in FIG. 1, the content from the third party system 130 may be a description of a social networking system user's action on the third-party system 130; however, the description may be generated from any suitable content from the third-party system 130, such as information stored by the third-party system 130, promotions offered by the third-party system 130, products or services offered by the third-party system, or any other suitable information. As described above in conjunction with FIGS. 1 and 3, the interface element associated with the third-party system 130 is generated from a definition associated with the third-party system 130. The definition may be communicated to the social networking system 140 when the third-party system 130 communicates the content used to generate the description or may be retrieved from the content store 310 or user profile store 305 of the social networking system 140.

The description is presented 410 to one or more users of the social networking system 140. For example, the newsfeed manager 335 presents 410 a story describing the content to one or more users connected to a brand page or user profile associated with the third-party system 130 and/or to one or more users connected to a user that performed an action specified by the description. However, the description may be presented 410 to social networking system users using any suitable method, such as via a message communicated to one or more users via e-mail or text messaging, via a notification channel, or via any other suitable method.

After presenting the description of the content from the third-party system, the action logger 315 or the newsfeed manager 335 receives 415 a selection of the interface element associated with the third-party system 130 from a user and transmits 420 a request to perform the action associated with the selected interface element to the third-party system 130 via the network 220. An identifier of the social networking system user selecting the interface element is determined form the action logger 315 or from the action log 320 and a command used by the third-party system 130 to perform the action associated with the selected interface element is determined from the definition of the interface element. Additional information, such as an object on which the action is to be performed, may be retrieved from the description or from another source and included in the request transmitted 420 to the third-party system 130.

The social networking system 140 receives 425 a description of the action after the third-party system 130 performs the action identified in the request. For example, the social networking system 140 receives 425 a confirmation that the action was performed or an error message if the third-party system was unable to perform the action. The received description of the action is stored in the action log 320 and a connection between the description of the action and the user that selected the interface element is stored in the edge store 330. In one embodiment, the newsfeed manager 335 notifies 430 one or more social networking system users of the action. For example, a story describing the action performed on the third-party system 130 is presented to one or more users associated with the user that selected the interface element. In one embodiment, the newsfeed manager 335 modifies the appearance of the selected interface element in the description presented to the social networking system user selecting the interface element when a confirmation message is received from the third-party system 130. For example, the selected interface element is modified to present information indicating that the action was performed by the third-party system 130.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving content from a third-party system for presentation to users of a social networking system, the third-party system associated with a domain different than a domain of the social networking system;
generating a description of the content from the third party system, the description including at least one interface element associated with an action on the third-party system;
presenting the description of the content including the at least one interface element to one or more users of the social networking system; and
transmitting a request to perform the action on the third-party system responsive to receiving an interaction with the at least one interface element from a user.

2. The method of claim 1, further comprising:
receiving a description of the action on the third-party system from the third party system.

3. The method of claim 2, further comprising:
storing the description of the action and an association between the description of the action and the user.

4. The method of claim 2, further comprising:
presenting a modified interface element associated with the action on the third-party system to the user after receiving the description of the action on the third-party system from the third-party system.

5. The method of claim 4, wherein the modified interface element includes data indicating the action was performed by the third-party system.

6. The method of claim 2, further comprising:
notifying one or more users of the social networking system connected to the user of the description of the action and of the user.

7. The method of claim 6, wherein notifying one or more users of the social networking system connected to the user of the description of the action and of the user comprises:
presenting a story describing the action and the user to the one or more users of the social networking system connected to the user.

8. The method of claim 1, wherein the request to perform the action on the third-party system includes a description of the action and identifying information associated with the user.

9. The method of claim 8, wherein the identifying information associated with the user comprises login information associated with the user and with the third-party system.

10. The method of claim 8, wherein the request to perform the action on the third-party system further comprises an identifier of an object on which the action is performed.

11. The method of claim 1, wherein generating the description of the content from the third party system comprises:
retrieving a description of an interface element associated with the action on the third-party system, the description identifying data for presentation, the third-party system, and a command for the third-party system; and
generating the description of the content based at least in part on the retrieved description of the interface element.

12. A method comprising:
presenting a description of content associated with a third-party system to one or more users of a social networking system including at least one interface element associated with an action on the third-party system, the third-party system associated with a domain different than a domain of the social networking system;
receiving an interaction with the at least one interface element associated with the action on the third party system from a user; and
transmitting a request to perform the action on the third-party system responsive to receiving the interaction, the request including a command for the third-party system to perform the action associated with the at least one interface element.

13. The method of claim 12, further comprising:
storing a description of the action received from the third-party system when the action was performed and an association between the description of the action and the user.

14. The method of claim 12, further comprising:
presenting a modified interface element associated with the action on the third-party system to the user after receiving the description of the action on the third-party system from the third-party system, the modified interface element includes data indicating the action was performed by the third-party system.

15. The method of claim 12, further comprising:
notifying one or more users of the social networking system connected to the user of the description of the action and of the user.

16. The method of claim 15, wherein notifying one or more users of the social networking system connected to the user of the description of the action and of the user comprises:
presenting a story describing the action and the user to the one or more users of the social networking system connected to the user.

17. The method of claim 12, wherein the request to perform the action on the third-party system includes identifying information associated with the user.

18. The method of claim 12, wherein the request to perform the action on the third-party system further comprises an identifier of an object on which the action is performed.

19. A method comprising:
transmitting content from a third-party system to a social networking system for presentation to users of the social networking system, the third-party system associated with a domain different than the domain of the social networking system;
receiving a request to perform an action on the third-party system from the social networking system, the request identifying a user and a command for performing the action by the third-party system;
performing the action on the third-party system by retrieving an account associated with the identified user and executing the command; and
transmitting a confirmation that the action was performed to the social networking system.

20. The method of claim 19, wherein transmitting the content from a third-party system to a social networking system for presentation to users of the social networking system comprises:
transmitting a description of an interface element for presentation by the social networking system, the description identifying data for presentation, the third-party system, and the command for performing the action on the third-party system.
